(19) United States
(12) Patent Application Publication
(10) Pub. No.: US 2019/0032756 A1
(43) Pub. Date: Jan. 31, 2019

(54) Ball Variator Continuously Variable Transmission

(71) Applicant: Dana Limited, Maumee, OH (US)

(72) Inventors: Sebastian J. Peters, Leander, TX (US); Patrick Sexton, Leander, TX (US)

(21) Appl. No.: 16/046,103

(22) Filed: Jul. 26, 2018

Related U.S. Application Data
(60) Provisional application No. 62/539,162, filed on Jul. 31, 2017.

(51) Int. Cl. F16H 15/50

(52) U.S. Cl. CPC F16H 15/503

(57) ABSTRACT

Provided herein is a variator assembly including a first rotatable shaft operably coupleable to a source of rotational power; and a variator having a first traction ring assembly and a second traction ring assembly in contact with a plurality of balls, wherein each ball of the plurality of balls has a tiltable axis of rotation, the variator is coaxial with the first rotatable shaft, wherein the first rotatable shaft is operably coupled to a sun assembly, the sun assembly located radially inward of, and in contact with, the plurality of balls.

### RELATED APPLICATION

This application claims the benefit of and priority to U.S. Provisional Application No. 62/539,162 filed on Jul. 31, 2017, which is herein incorporated by reference.

### BACKGROUND

A driveline including a continuously variable transmission allows an operator or a control system to vary a drive ratio in a stepless manner, permitting a power source to operate at its most advantageous rotational speed.

### SUMMARY

Provided herein is a variator assembly including: a first rotatable shaft operably coupleable to a source of rotational power; and a variator having a first traction ring assembly and a second traction ring assembly in contact with a plurality of balls, wherein each ball of the plurality of balls has a tiltable axis of rotation, wherein the variator is coaxial with the first rotatable shaft, and wherein the first rotatable shaft is operably coupled to a sun assembly, the sun assembly located radially inward of, and in contact with, the plurality of balls.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic illustration of a variator having a split idler assembly.

FIG. 5 is a schematic illustration of a variator having a single idler element.

FIG. 6 is a schematic illustration of a variator having a split main shaft.

FIG. 7 is a schematic illustration of another variator having a split main shaft.

FIG. 8 is a schematic illustration of yet another variator having a split main shaft.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

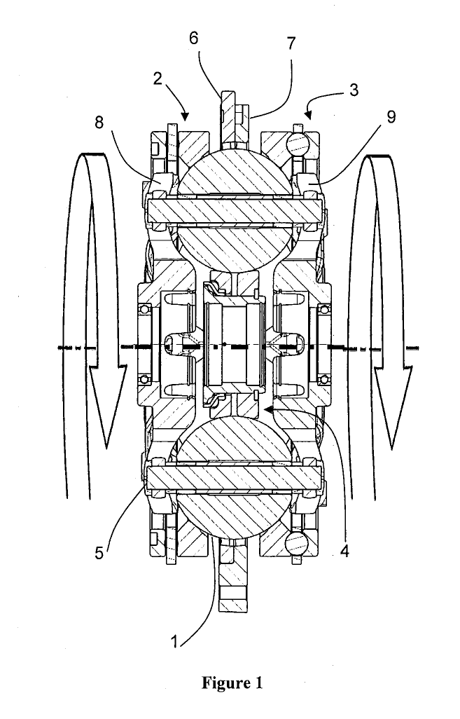

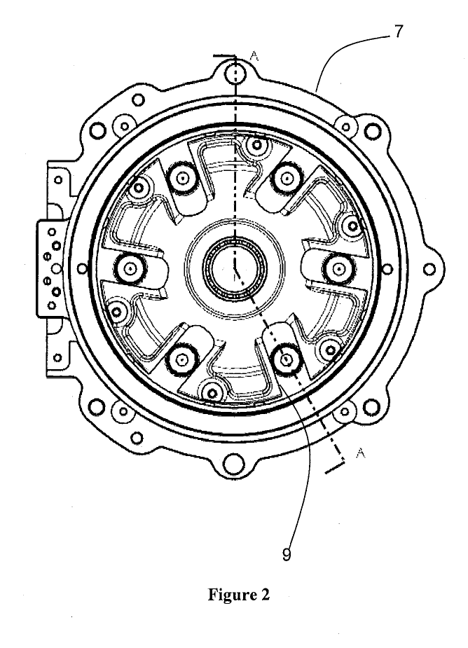

Provided herein are configurations of CVTs based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

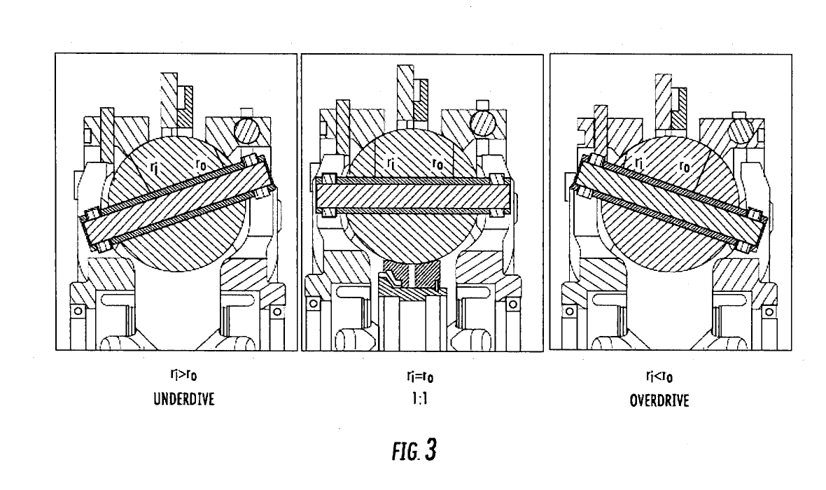

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

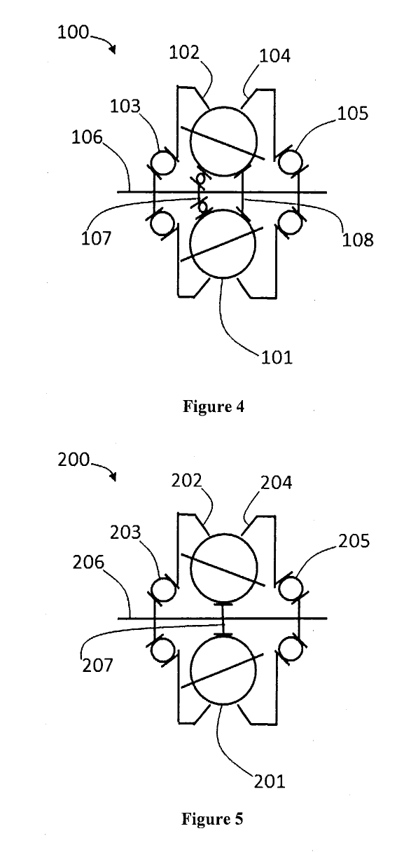

Referring now to FIG. 4, in some embodiments, a variator 100 is similar to the variator depicted in FIGS. 1-3. For description purposes, only the differences between the variator 100 and the variator of FIGS. 1-3 will be described. The variator 100 includes a number of balls 101 in contact with a first traction ring assembly 102 and a second traction ring assembly 104.

In some embodiments, the first traction ring assembly 102 is coupled to a bearing 103.

In some embodiments, the bearing 103 is an axial force generator device, such as a ball-and-cam ramp device that provide torque dependent axial force. The second traction ring assembly 104 is coupled to a bearing 105. In some embodiments, the bearing 105 is an axial force generator device. The balls 101, the first traction ring assembly 102, and the second traction ring assembly 104 are coaxial with a rotatable main shaft 106. The main shaft 106 is coupled to an idler assembly, such as the idler assembly 4, having a first idler 107 and a second idler 108.

In some embodiments, the first idler 107 includes a bearing, such as an angular contact bearing to facilitate coupling between the main shaft 106 and the balls 101.

In some embodiments, the main shaft 106 is adapted to receive or transmit a rotational power. During operation of the CVP 100, rotational power is optionally transmitted to the CVP 100 through the main shaft 106, the first traction ring assembly 102, or the second traction ring assembly 104. It should be appreciated, that the said components are optionally adapted to transmit power out of the CVP 100.

Turning now to FIG. 5, in some embodiments, a variator 200 is similar to the variator depicted in FIGS. 1-3. For description purposes, only the differences between the variator 200 and the variator of FIGS. 1-3 will be described. The variator 200 includes a number of balls 201 in contact with a first traction ring assembly 202 and a second traction ring assembly 204.

In some embodiments, the first traction ring assembly 202 is coupled to a bearing 203.

In some embodiments, the bearing 203 is an axial force generator device, such as a ball-and-cam ramp device that provide torque dependent axial force. The second traction ring assembly 204 is coupled to a bearing 205.

In some embodiments, the bearing 205 is an axial force generator device. The balls 201, the first traction ring assembly 202, and the second traction ring assembly 204 are coaxial with a rotatable main shaft 206. The main shaft 206 is coupled to an idler assembly 207.

In some embodiments, the main shaft 206 is adapted to receive or transmit a rotational power. During operation of the CVP 200, rotational power is optionally transmitted to the CVP 200 through the main shaft 206, the first traction ring assembly 202, or the second traction ring assembly 204. It should be appreciated, that the said components are optionally adapted to transmit power out of the CVP 200.

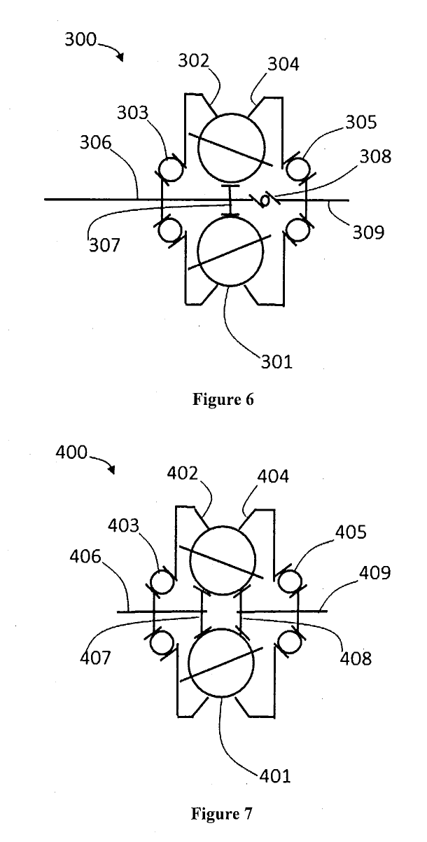

Referring now FIG. 6, in some embodiments, a variator 300 is similar to the variator depicted in FIGS. 1-3. For description purposes, only the differences between the variator 300 and the variator of FIGS. 1-3 will be described. The variator 300 includes a number of balls 301 in contact with a first traction ring assembly 302 and a second traction ring assembly 304.

In some embodiments, the first traction ring assembly 302 is coupled to a bearing 303.

In some embodiments, the bearing 303 is an axial force generator device, such as a ball-and-cam ramp device that provide torque dependent axial force. The second traction ring assembly 304 is coupled to a bearing 305.

In some embodiments, the bearing 305 is an axial force generator device. The balls 301, the first traction ring assembly 302, and the second traction ring assembly 304 are coaxial with a rotatable main shaft 306. The main shaft 306 is coupled to an idler assembly 307.

In some embodiments, the main shaft 306 is adapted to receive or transmit a rotational power.

In some embodiments, the CVP 300 includes an output shaft 309 arranged coaxially with the main shaft 306 and coupled axially with a bearing 308. During operation of the CVP 300, rotational power is optionally transmitted to the CVP 300 through the main shaft 306, the output shaft 308, the first traction ring assembly 302, or the second traction ring assembly 304. It should be appreciated, that the said components are optionally adapted to transmit power out of the CVP 300.

Referring now FIG. 7, in some embodiments, a variator 400 is similar to the variator depicted in FIGS. 1-3. For description purposes, only the differences between the variator 400 and the variator of FIGS. 1-3 will be described. The variator 400 includes a number of balls 401 in contact with a first traction ring assembly 402 and a second traction ring assembly 404.

In some embodiments, the first traction ring assembly 402 is coupled to a bearing 403.

In some embodiments, the bearing 403 is an axial force generator device, such as a ball-and-cam ramp device that provide torque dependent axial force. The second traction ring assembly 404 is coupled to a bearing 405. In some embodiments, the bearing 405 is an axial force generator device. The balls 401, the first traction ring assembly 402, and the second traction ring assembly 404 are coaxial with a rotatable main shaft 406. The main shaft 406 is coupled to a first idler ring 407 in contact with the balls 401.

In some embodiments, the main shaft 406 is adapted to receive or transmit a rotational power.

In some embodiments, the CVP 400 includes an output shaft 409 arranged coaxially with the main shaft 406. The output shaft 409 is operably coupled to a second idler ring 408 in contact with the balls 401. During operation of the CVP 400, rotational power is optionally transmitted to the CVP 400 through the main shaft 406, the second idler ring 408, the first traction ring assembly 402, or the second traction ring assembly 404. It should be appreciated, that the said components are optionally adapted to transmit power out of the CVP 400.

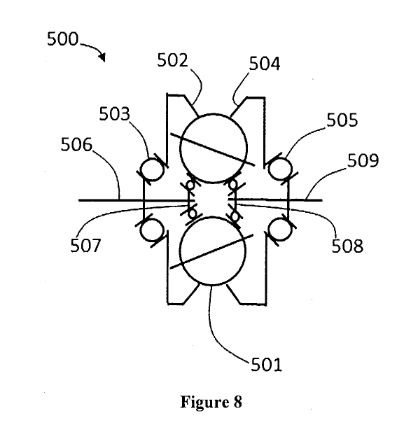

Referring now FIG. 8, in some embodiments, a variator 500 is similar to the variator depicted in FIGS. 1-3. For description purposes, only the differences between the variator 500 and the variator of FIGS. 1-3 will be described. The variator 500 includes a number of balls 501 in contact with a first traction ring assembly 502 and a second traction ring assembly 504.

In some embodiments, the first traction ring assembly 502 is coupled to a bearing 503.

In some embodiments, the bearing 503 is an axial force generator device, such as a ball-and-cam ramp device that provide torque dependent axial force. The second traction ring assembly 504 is coupled to a bearing 505.

In some embodiments, the bearing 505 is an axial force generator device. The balls 501, the first traction ring assembly 502, and the second traction ring assembly 504 are coaxial with a rotatable main shaft 506. The main shaft 506 is coupled to a first idler ring 507 coupled by a bearing, such as an angular contact bearing, to the balls 501.

In some embodiments, the main shaft 506 is adapted to receive or transmit a rotational power.

In some embodiments, the CVP 500 includes an output shaft 509 arranged coaxially with the main shaft 506. The output shaft 509 is operably coupled to a second idler ring 508 coupled by a bearing, such as an angular contact bearing, to the balls 501. During operation of the CVP 500, rotational power is optionally transmitted to the CVP 500 through the main shaft 506, the second idler ring 508, the first traction ring assembly 502, or the second traction ring assembly 504. It should be appreciated, that the said components are optionally adapted to transmit power out of the CVP 500.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A variator assembly comprising:
a first rotatable shaft operably coupleable to a source of rotational power; and
a variator having a first traction ring assembly and a second traction ring assembly in contact with a plurality of balls, wherein each ball of the plurality of balls has a tiltable axis of rotation, the variator is coaxial with the first rotatable shaft,
wherein the first rotatable shaft is operably coupled to a sun assembly, the sun assembly located radially inward of, and in contact with, the plurality of balls.

2. The variator assembly of claim 1, further comprising a second shaft operably coupled to the second traction ring assembly, the second shaft arranged coaxial with the first rotatable shaft.

3. The variator assembly of claim 1, wherein the sun assembly comprises a single idler ring.

4. The variator assembly of claim 1, wherein the sun assembly comprises a first idler ring and a second idler ring.

5. The variator assembly of claim 1, wherein the first traction ring assembly is configured to receive a rotational power.

6. The variator assembly of claim 1, wherein the first traction ring assembly is configured to transmit a rotational power out of the variator.

7. The variator assembly of claim 1, wherein the second traction ring assembly is configured to receive a rotational power.

8. The variator assembly of claim 1, wherein the second traction ring assembly is configured to transmit a rotational power out of the variator.

9. The variator assembly of claim 2, wherein the second shaft is configured to transmit power out of the variator.

10. The variator assembly of claim 2, wherein the second shaft is configured to receive a rotational power.

11. The variator assembly of claim 4, wherein the first idler ring is coupled to the balls.

12. The variator assembly of claim 4, wherein the first idler ring couples with an angular contact bearing to the balls.

13. The variator assembly of claim 11, wherein the second idler ring is coupled to the balls.

14. The variator assembly of claim 12, wherein the second idler ring is coupled to the balls.

15. The variator assembly of claim 12, wherein the second idler ring couples with an angular contact bearing to the balls.
